(19) United States
(12) Patent Application Publication
(10) Pub. No.: US 2026/0186521 A1
(43) Pub. Date: Jul. 2, 2026

(54) CURRENT SOURCE CIRCUIT AND METHOD FOR GENERATING ZERO TEMPERATURE COEFFICIENT CURRENT

(71) Applicant: Nuvoton Technology Corporation, Hsinchu Science Park (TW)

(72) Inventor: Sheng-Wei WANG, Tainan City (TW)

(21) Appl. No.: 19/353,264

(22) Filed: Oct. 8, 2025

(30) Foreign Application Priority Data
Dec. 30, 2024 (TW) 113151425

(51) Int. Cl. G05F 3/26

(52) U.S. Cl. CPC G05F 3/267

(57) ABSTRACT

A current source circuit including a current mirror, a bias resistor, a first transistor, a second transistor and a first current source is provided. The current mirror is coupled between a supply voltage terminal, a first node, and a second node and outputs a first current and a second current to the first node and the second node respectively. The bias resistor is coupled between the first node and a third node and controls the first current according to a voltage difference between the first node and the third node. The first transistor is coupled between the third node and a reference voltage terminal. The second transistor is connected between the second node and the reference voltage terminal. The first current source outputs a third current to the second node to generate a fourth current. The third current has negative temperature coefficient.

### CROSS REFERENCE TO RELATED APPLICATIONS

This application claims priority of Taiwan Patent Application No. 113151425, filed on Dec. 30, 2024, the entirety of which is incorporated by reference herein.

### BACKGROUND OF THE INVENTION

### Field of the Invention

The present invention relates to a current source circuit, and, in particular, to a current source circuit and method capable of generating a current with zero temperature coefficient or positive temperature coefficient.

### Description of the Related Art

Today's circuits are often affected by temperature. For example, the output current may increase or decrease, and this may be caused by a rise in temperature. When a precise and stable current source is needed, these variations may cause unexpected errors or inaccuracies in the circuit operations. To eliminate or reduce the temperature effects, additional resistors can be added to the current circuit. However, as the cost of circuit design and manufacturing increase, the circuit area is also a critical issue that should be considered today. Since additional resistors require a large surface area, a solution is needed for saving space while simultaneously providing a stable output current.

### BRIEF SUMMARY OF THE INVENTION

According to an embodiment, the present invention provides a current source circuit, comprising a current mirror, a bias resistor, a first transistor, a second transistor and a first current source. The current mirror is coupled between a supply voltage terminal, a first node, and a second node and is configured to output a first current and a second current to the first node and the second node respectively. The bias resistor is coupled between the first node and a third node to control the first current according to a voltage difference between the first node and the third node. The first transistor has a first terminal coupled to the third node, and a second terminal and a first control terminal both coupled to a reference voltage terminal. The second transistor has a third terminal coupled to the second node, and a fourth terminal and a second control terminal both coupled to the reference voltage terminal. The first current source is configured to output a third current to the second node to generate a fourth current. The third current has a negative temperature coefficient. Wherein, the fourth current equals the first current plus the second current.

In an embodiment, the current source circuit further comprises a second current source, configured to extract a fifth current from the third node to generate a sixth current flowing through the first transistor, wherein the fifth current has a negative temperature coefficient, and the sixth current equals the first current minus the fifth current

In an embodiment, the first current source further comprises a fifth transistor, a sixth transistor, and a seventh transistor. The fifth transistor has a ninth terminal coupled to the second node, a tenth terminal coupled to the supply voltage terminal, and a fifth control terminal. The sixth transistor has an eleventh terminal and a sixth control terminal coupled to each other, and a twelfth terminal coupled to the supply voltage terminal. The seventh transistor has a thirteenth terminal coupled to the eleventh terminal of the sixth transistor, a seventh control terminal coupled to the third node, and a fourteenth terminal coupled to the reference voltage terminal. Wherein, the fifth control terminal of the fifth transistor is coupled to the sixth control terminal of the sixth transistor.

In an embodiment, the second current source further comprises an eighth transistor, having a fifteenth terminal and an eighth control terminal both coupled to the third node, and a sixteenth terminal coupled to the reference voltage terminal.

According to another embodiment, the current source circuit further comprises a first switch and a second switch. The first switch is coupled between the first current source and the second node. The second switch is coupled between the second current source and the third node.

In an embodiment, the first switch and the second switch are configured to be turned on in a zero temperature coefficient mode, and are configured to be turned off in a positive temperature coefficient mode.

According to an embodiment, the present invention provides a method for generating zero temperature coefficient current, comprising outputting, using a current mirror, a first current and a second current to a first node and a second node respectively; outputting, using a first current source, a third current to the second node to generate a fourth current flowing out from the second node, wherein the third current has a negative temperature coefficient, and the fourth current equals the second current plus the third current; and extracting, using a second current source, a fifth current from a third node to generate a sixth current, wherein the fifth current has a negative temperature coefficient, and the sixth current equals the first current minus the fifth current. The first current is controlled by a bias resistor, and the bias resistor is coupled between the first node and the third node.

### BRIEF DESCRIPTION OF THE DRAWINGS

The present invention can be more fully understood by reading the subsequent detailed description and examples with references made to the accompanying drawings, wherein:

FIG. 1 is a schematic diagram of a current source circuit described in accordance with the embodiments of the present invention.

FIG. 2 is a circuit diagram of a current source circuit described in accordance with the embodiments of the present invention.

FIG. 3 is a schematic diagram of a current source circuit with a switching function described in accordance with the embodiments of the present invention.

### DETAILED DESCRIPTION OF THE INVENTION

The following description is made for the purpose of illustrating the general principles of the invention and should not be taken in a limiting sense. The scope of the invention is best determined by reference to the appended claims.

To make the above and other objectives, features, and advantages of the present invention more apparent and easier to understand, preferred embodiments are described below in detail with reference to the accompanying drawings.

The following outlines some embodiments to enable those skilled in the art of the present invention to more easily understand the embodiments of the invention. However, these embodiments are merely examples and are not intended to limit the scope of the invention. It should be understood that those skilled in the art of the present invention may adjust the described embodiments as needed, for example, by altering the process sequence and/or including more or fewer steps than those described herein, without departing from the scope of the embodiments of the present invention.

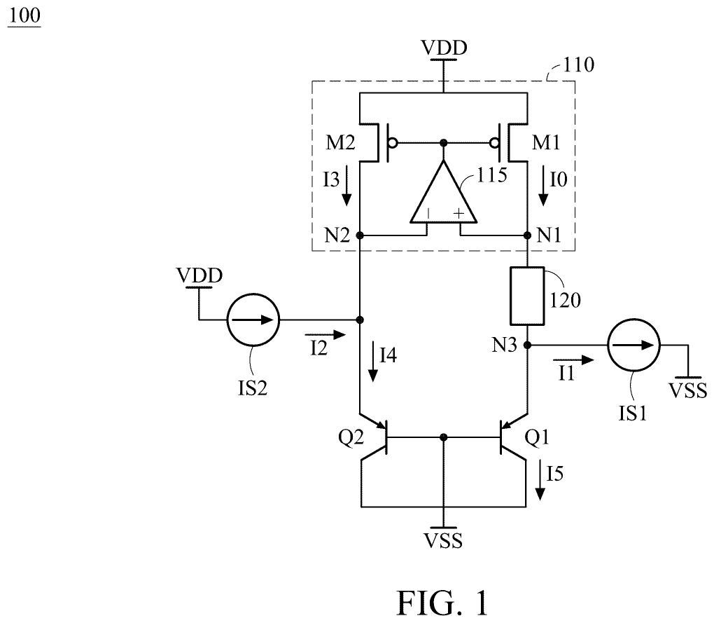

FIG. 1 is a schematic diagram of a current source circuit 100 described in accordance with the embodiments of the present invention. The current source circuit 100 comprises a current mirror 110, a bias resistor 120, transistors Q1 and Q2, and a current source IS2. The current mirror 110 is coupled to a supply voltage terminal VDD, and outputs currents I0 and I3 to nodes N1 and N2 respectively. The bias resistor 120 is coupled between the node N1 and a node N3. A first terminal of the transistor Q1 is coupled to the node N3, and both a second terminal and a control terminal of the transistor Q1 are coupled to a reference voltage terminal VSS. A first terminal of the transistor Q2 is coupled to the node N2, and both a second terminal and a control terminal od the transistor Q2 are coupled to the reference voltage terminal VSS. That is, the control terminals of the transistors Q1 and Q2 are coupled to each other. The current source IS2 has a negative temperature coefficient (i.e., decrease as the temperature rises), and is configured to output a current I2 to node N2 to generate a current I4 flowing through the transistor Q1. The current I4 equals the sum of the currents I2 and I3.

The current mirror 110 comprises transistors M1 and M2, and an operational amplifier 115. A first terminal of the transistor M1 is coupled to the supply voltage terminal VDD, a second terminal of the transistor M1 is coupled to the node N1, and a control terminal of transistor M1 is coupled to an output terminal of the operational amplifier 115. A first terminal of the transistor M2 is coupled to the supply voltage terminal VDD, a second terminal of transistor M2 is coupled to the node N2, and a control terminal of transistor M2 is coupled to the output terminal of the operational amplifier 115. That is, the control terminals of the transistors M1 and M2 are both coupled to the output terminal of the operational amplifier 115. The operational amplifier 115 further comprises a first input terminal (labeled “+”) and a second input terminal (labeled “−”) coupled to the nodes N1 and N2 respectively.

A first voltage difference VBE1 is between the first terminal and the control terminal of the transistor Q1, and a second voltage difference VBE2 is between the first terminal and the control terminal of the transistor Q2. When a virtual short is formed between the first and second input terminals of the operational amplifier 115, a voltage at the node N2 approaches the second voltage difference VBE2 such that a voltage across the bias resistor 120 equals VBE2-VBE1. Supposed that the bias resistor 120 has a resistance Rbias, the current I0 can be derived using the following equation:

$$I 0 = \frac{VBE 2 - VBE 1}{R bias} \qquad equation ( 1 )$$

That is, the bias resistor 120 can be used to control a magnitude of the current I0. Furthermore, as shown in FIG. 1, the transistors Q1 and Q2 are bipolar junction transistor (BJTs), thus, both the first voltage difference VBE1 and the second voltage difference VBE2 decrease as the temperature rises. However, generally, compared with the second voltage difference VBE2, the first voltage difference VBE1 is configured with a larger decreasing margin. This results in an increasing of the voltage across the bias resistor 120 as the temperature rises, thereby causing the current I0 to increase as the temperature rises, thus, the current I0 has a positive temperature coefficient.

To reduce or eliminate this characteristic that the current I0 increases as the temperature rises, the current source IS2 outputs the current I2 having a negative temperature coefficient to the node N2. This causes the second voltage difference VBE2 of the transistor Q2 to have the same decreasing margin as the first voltage difference VBE1 of the transistor Q1 when the temperature rises, thereby achieving the effect of temperature compensation, and eliminating or reducing the increasing margin of the current I0 as the temperature rises. However, the design of the current source IS2 requires the consideration of the current mirror 110, the transistors Q1 and Q2, the bias resistor 120 and any components included in the current source circuit 100, which may increase the design complexity and difficulty of the current source IS2. Therefore, as shown in FIG. 1, a current source IS1 having a negative temperature coefficient is further added to the current source circuit 100 to design the current source IS2 meeting the requirements of the current source circuit 100 efficiently.

The current source IS1 is configured to extract a current I1 from the node N3 to generate a current I5 flowing through the transistor Q1, wherein the current I5 equals the current I0 minus the current I1. Through configuring the ratio between the currents I1 and I2 appropriately, such as configuring a magnitude of the current I2 to be a multiple of a magnitude of the current I1, the current source I2 can be efficiently and easily designed to eliminate or reduce the effect of the temperature on the current I0.

It should be noted that, as shown in FIG. 1, the transistors M1 and M2 included in the current mirror 110 are P-type metal oxide semiconductor transistor (PMOS), and the transistors Q1 and Q2 included in the current mirror 110 are PNP-type BJT, while the transistors M1 and M2 may also be N-type MOS, and the transistors Q1 and Q2 may also be NPN-type BJT.

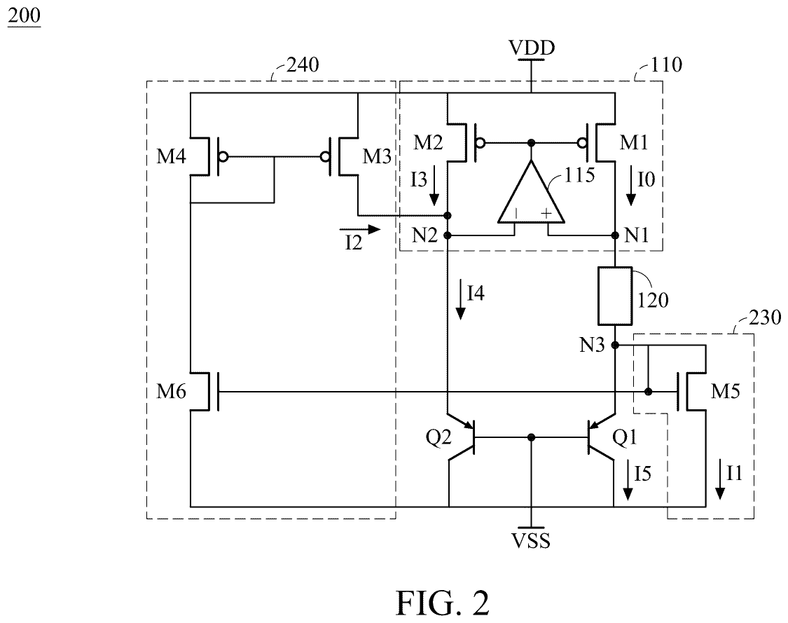

FIG. 2 is a circuit diagram of a current source circuit 200 described in accordance with the embodiments of the present invention. Similar to the current source circuit 100, the current source circuit 200 comprises the current mirror 110, the transistors Q1 and Q2, and the bias resistor 120. Wherein, the current source circuit 200 further comprises current sources 230 and 240, and the current sources 230 and 240 are an example of the current sources IS1 and IS2 respectively.

The current source 230 comprises a transistor M5, having a first terminal and a control terminal both coupled to the node N3, and a second terminal coupled to the reference voltage terminal VSS. The current source 240 comprises transistors M3, M4, and M6, wherein the transistor M3 has a first terminal coupled to the node N2, and a second terminal coupled to the supply voltage terminal VDD. The transistor M4 has a first terminal and a control terminal both coupled to the control terminal of the transistor M3, and a second terminal coupled to the supply voltage terminal VDD. The transistor M6 has a first terminal coupled to the first terminal of the transistor M4, a second terminal coupled to the reference voltage terminal VSS, and a control terminal coupled to the control terminal of the transistor M5.

The following describes in detail how the configuration of the currents I0, I1, and I2 achieves the elimination or reduction of the increasing margin of the current I0 as the temperature rises. Supposed that a current ratio between the transistors M1 and M2 is 1:M, a relationship between the currents I3 and I0 can be derived as I3=M*I0. Thus, a relationship between the currents I0, I2, I3, and I4 can be derived as:

$$I 4 = I 2 + I 3 = I 2 + M * I 0 \qquad equation ( 2 )$$

Meanwhile, the voltage across the bias resistor 120 can be expressed as:

$$VBE 2 - VBE 1 = {V}_{T} * ln ( I 2 + M * I 0 ) - {V}_{T} * ln ( I 0 - I 1 ) = {V}_{T} * ln ( \frac{M * I 0 + I 2}{I 0 - I 1} ) \qquad equation ( 3 )$$

Wherein, V_{T} is the thermal voltage (kT/q).

Then, the equation (3) is rewritten as follow through the Taylor series to calculate a magnitude of a temperature compensation current at temperature S:

$${V}_{T} * ln ( \frac{M * I 0 + I 2}{I 0 - I 1} ) \approx ( {V}_{S} + α * Δ T ) ( ln ( M ) + \frac{r {β}_{1} Δ T}{M * I 0} ) = {V}_{S} * ln ( M ) + ( α * ln ( M ) + \frac{r {β}_{1} {V}_{S}}{M * I 0} ) * ΔT + \frac{α r {β}_{1}}{M * I 0} * Δ {T}^{2} \approx {V}_{S} * ln ( M ) + ( α * ln ( M ) + \frac{r {β}_{1} {V}_{S}}{M * I 0} ) * ΔT \qquad equation ( 4 )$$

Wherein, α is a slope of V_{T} versus temperature, β₁ is a slope of the current I1 versus temperature, and r is a multiple of the current I2 to the current I1. Furthermore, I0>>I1, and I0>>I2. Meanwhile, if a coefficient of ΔT obtained by the equation (4)

$$( α * ln ( M ) + \frac{r {β}_{1} {V}_{S}}{M * I 0} )$$

equals 0, the temperature effect of V_{T} can be eliminated, and the generated VBE2-VBE1 can be confirmed to be a voltage with zero temperature coefficient. With this voltage and referring to the equation (1), the current I0 with zero temperature coefficient can be obtained.

Meanwhile, referring to FIG. 2, supposed that a current ratio between the transistors M5 and M6 is 1:K, and a current ratio between the transistors M4 and M3 is 1:N, a relationship between the currents I2 and I1 can be derived as I2=N*K*I1. Then, a part of the equation (4) is rewritten as:

$$α * ln ( M ) + \frac{N * K * {β}_{1} {V}_{S}}{M * I 0} = 0$$

Therefore, during the design process, it is only necessary to consider the currents I0 and I1, and characteristics of the current I1 at temperature S to find a value of r. This can achieve the elimination and reduction of the increasing margin of the current I0 while can achieve the efficiently and easily design of the current source IS2 and 240 by adding the current sources IS1 and 230 to the current source circuit 100 and 200 respectively.

It should be noted that, as shown in FIG. 2, the transistor M5 included in the current source 230 and the transistor M6 included in the current source 240 are NMOS, and the transistors M3 and M4 included in the current source 240 are PMOS, while the transistors M5 and M6 may also be PMOS, and the transistors M3 and M4 may also be NMOS.

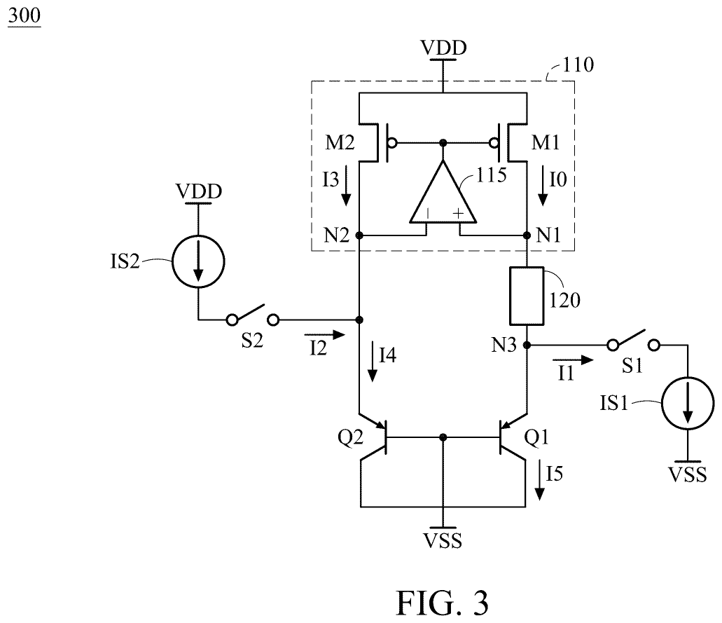

FIG. 3 is a schematic diagram of a current source circuit 300 with a switching function described in accordance with the embodiments of the present invention. Similar to the current source circuit 100, the current source circuit 300 comprises the current mirror 110, the transistors Q1 and Q2, and the bias resistor 120. The difference between the current source circuits 300 and 100 is that the current source circuit 300 further comprises switches S1 and S2. The switch S1 is coupled between the current source IS1 and the node N3, and the switch S2 is coupled between the current source IS2 and node N2.

When the switches S1 and S2 are turned on, the function of the current source circuit 300 can be the same as the current source circuit 100, that is, generates the current I0 with a zero temperature coefficient (i.e., not affected by the temperature) or a quite small temperature coefficient (i.e., little affected by the temperature). Meanwhile, the current source circuit 300 can be regarded as in a zero temperature coefficient mode. On the contrary, when the switches S1 and S2 are turned off, since the current source IS1 stops extracting the current I1 from th3 nod3 N3, and the current source IS2 stops outputting the current I2 to the node N2, the current source circuit 300 generates the current I0 with positive temperature coefficient. Meanwhile, the current source circuit 300 can be regarded as in a positive temperature coefficient mode.

Wherein, the switches S1 and S2 may be controlled by a controller (not shown), such as microcontroller, microprocessor, and the likes, to switch between the zero temperature coefficient mode and the positive temperature coefficient mode. In an embodiment, in response to the requirements of stable current source, the controller may control the switches S1 and S2 to be turned on such that the currents I1 and I2 compensate for the current I0 to eliminate or reduce the increasing margin of the current I0 as the temperature rises. In another embodiment, in response to the requirements related to the temperature, such as being a part of the thermometer circuit, the controller may control the switches S1 and S2 to be turned off such that the currents I1 and I2 cannot compensate for the current I0 to perform positive temperature coefficient or other temperature-related operations.

The present invention provides a current source circuit, comprising a current mirror, a plurality of transistors, a bias transistor, one or more current sources with a negative temperature coefficient. The current mirror generates the currents I0 and I3, and outputs these currents to the nodes N1 and N2 respectively, wherein the ratio between the currents I0 and I3 is 1:M, that is, I3=M*I0. The current source IS2 outputs the current I2 to the node N2 to generate the current I4 outputting from the node N2, that is, I4=M*I0+I2. Wherein, the bias resistor is used to control the magnitude of the current I0. The current source IS1 extracts the current I1 from the node N3 to generate the current I5 flowing through the transistor Q1, that is, I5=I0−1.

Furthermore, by configuring the plurality of transistors of the current sources IS1 and IS2, the magnitude of the current I2 is the multiple of the magnitude of the current I1, causing to efficiently and easily achieve the elimination or reduction of the increasing margin of the current I0 as the temperature rises through adding and/or extracting current by using the current source with negative temperature coefficient. Meanwhile, since the current sources used in the present invention are merely composed of transistors, compared with the traditional method of using additional resistors to reduce the current, the present invention further achieves the effect of saving circuit area.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A current source circuit, comprising:
a current mirror, coupled between a supply voltage terminal, a first node, and a second node, wherein the current mirror is configured to output a first current and a second current to the first node and the second node respectively;
a bias resistor, coupled between the first node and a third node to control the first current according to a voltage difference between the first node and the third node;
a first transistor, having a first terminal coupled to the third node, and a second terminal and a first control terminal both coupled to a reference voltage terminal;
a second transistor, having a third terminal coupled to the second node, and a fourth terminal and a second control terminal both coupled to the reference voltage terminal; and
a first current source, configured to output a third current to the second node to generate a fourth current, wherein the third current has a negative temperature coefficient;
wherein the fourth current equals the first current plus the second current.

2. The current source circuit as claimed in claim 1, wherein the current mirror comprises:
a third transistor, having a fifth terminal coupled to the first node, and a sixth terminal coupled to the supply voltage terminal;
a fourth transistor, having a seventh terminal coupled to the second node, and an eighth terminal coupled to the supply voltage terminal; and
an operational amplifier, wherein an output terminal of the operational amplifier is coupled to both a third control terminal of the third transistor and a fourth control terminal of the fourth transistor, a first input terminal of the operational amplifier is coupled to the first node, and a second input terminal of the operational amplifier is coupled to the second node.

3. The current source circuit as claimed in claim 1, further comprising:
a second current source, configured to extract a fifth current from the third node to generate a sixth current flowing through the first transistor, wherein the fifth current has a negative temperature coefficient, and the sixth current equals the first current minus the fifth current.

4. The current source circuit as claimed in claim 3, wherein the first current source further comprises:
a fifth transistor, having a ninth terminal coupled to the second node, a tenth terminal coupled to the supply voltage terminal, and a fifth control terminal;
a sixth transistor, having an eleventh terminal and a sixth control terminal coupled to each other, and a twelfth terminal coupled to the supply voltage terminal; and
a seventh transistor, having a thirteenth terminal coupled to the eleventh terminal of the sixth transistor, a seventh control terminal coupled to the third node, and a fourteenth terminal coupled to the reference voltage terminal;
wherein the fifth control terminal of the fifth transistor is coupled to the sixth control terminal of the sixth transistor.

5. The current source circuit as claimed in claim 4, wherein the second current source further comprises:
an eighth transistor, having a fifteenth terminal and an eighth control terminal both coupled to the third node, and a sixteenth terminal coupled to the reference voltage terminal.

6. The current source circuit as claimed in claim 5, wherein:
a current flowing through the fifth transistor is a first multiple of a current flowing through the sixth transistor;
a current flowing through the seventh transistor is a second multiple of a current flowing through the eighth transistor; and
the third current is a third multiple of the fifth current, wherein the third multiple equals the first multiple times the second multiple.

7. The current source circuit as claimed in claim 1, further comprising:
a first switch, coupled between the first current source and the second node, wherein the first switch is configured to be turned on in a zero temperature coefficient mode, and is configured to be turned off in a positive temperature coefficient mode.

8. The current source circuit as claimed in claim 3, further comprising:
a first switch, coupled between the first current source and the second node; and
a second switch, coupled between the second current source and the third node;
wherein the first switch and the second switch are configured to be turned on in a zero temperature coefficient mode, and are configured to be turned off in a positive temperature coefficient mode.

9. A method for generating zero temperature coefficient current, comprising:
outputting, using a current mirror, a first current and a second current to a first node and a second node, respectively;
outputting, using a first current source, a third current to the second node to generate a fourth current flowing out from the second node, wherein the third current has a negative temperature coefficient, and the fourth current equals the second current plus the third current; and
extracting, using a second current source, a fifth current from a third node to generate a sixth current, wherein the fifth current has a negative temperature coefficient, and the sixth current equals the first current minus the fifth current;
wherein the first current is controlled by a bias resistor, and the bias resistor is coupled between the first node and the third node.

10. The method for generating zero temperature coefficient current as claimed in claim 9, further comprising:
turning on a first switch and a second switch in a zero temperature coefficient mode; and
turning off the first switch and the second switch in a positive temperature coefficient mode;
wherein the first switch is coupled between the first current source and the second node, and the second switch is coupled between the second current source and the third node.
